(19) United States
(12) Patent Application Publication
(10) Pub. No.: US 2009/0173492 A1
(43) Pub. Date: Jul. 9, 2009

(54) SURFACE ACTIVATED DOWNHOLE SPARK-GAP TOOL

(75) Inventor: Edward J. O'MALLEY, Houston, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 12/335,103

(22) Filed: Dec. 15, 2008

Related U.S. Application Data
(63) Continuation-in-part of application No. 11/434,685, filed on May 16, 2006.
(60) Provisional application No. 60/681,697, filed on May 17, 2005.

(51) Int. Cl. E21B 43/00; E21B 43/25; G01V 1/157

(52) U.S. Cl. 166/249; 166/65.1

(57) ABSTRACT

A completion mounted spark gap tool comprising a completion component housing; a spark gap device having a plurality of electrodes at the housing and configured to produce a shockwave having a frequency in the range of about 0.1 to about 100 HZ; a voltage source in operable communication with the electrodes and a method for far field stimulation.

### CROSS REFERENCE TO RELATED APPLICATION

This application is a continuation in part of application U.S. Ser. No. 11/434,685 filed May 16, 2006, which is a non-provisional application of U.S. Ser. No. 60/681,697, filed May 17, 2005, the contents of each of which are incorporated by reference herein in their entirety.

### BACKGROUND

Spark-gap tools are known in the hydrocarbon industry. These tools have not, however, gained strong acceptance in permanent completions primarily because they require a large voltage to function acceptably. Such voltage is often delivered to the spark-gap tool in a downhole environment through electrical conductors from a surface supply system. As one of ordinary skill in the art clearly recognizes, the longer the electrical conductor, the greater the voltage drop. For this reason the voltage at the surface supply needs to be even greater than that required to produce an acceptable arc at the spark-gap tool. Since many rig operators are uncomfortable with utilizing systems employing greater than 200 volts from a surface supply, the spark-gap tools' functionality has been limited. Moreover, because of the electrical requirements, other compromises are also made throughout the wellbore to accommodate power at the site of the spark-gap tool. Each of the above issues creates a lack of interest in the industry in using the spark-gap tools at all and where they are used, the term is a very limited wireline deployment for a specific test and removal from the well.

### SUMMARY

A completion mounted spark gap tool including a completion component housing; a spark gap device having a plurality of electrodes at the housing and configured to produce a shockwave having a frequency in the range of about 0.1 to about 100 HZ; a voltage source in operable communication with the electrodes

A method for far field stimulation including powering a spark gap device; generating a plurality of shockwaves having one or more dominant frequencies in the range of about 0.1 Hz to about 100 Hz over a period of time.

### BRIEF DESCRIPTION OF THE DRAWINGS

Referring now to the drawings wherein like elements are numbered alike in the several Figures:

FIGS. 1A and 1B are an extended schematic elevation view of a wellbore with the spark-gap tool deployed therein;

FIG. 2 is an expanded view of the circumscribed Section 2-2 in FIG. 1B;

FIG. 3 is an expanded view of the circumscribed view Section 3-3 in FIG. 1B;

FIG. 4 is a schematic elevation view of an alternate voltage operation arrangement;

FIG. 5 is a schematic elevation view of another alternate voltage generation arrangement.

### DETAILED DESCRIPTION

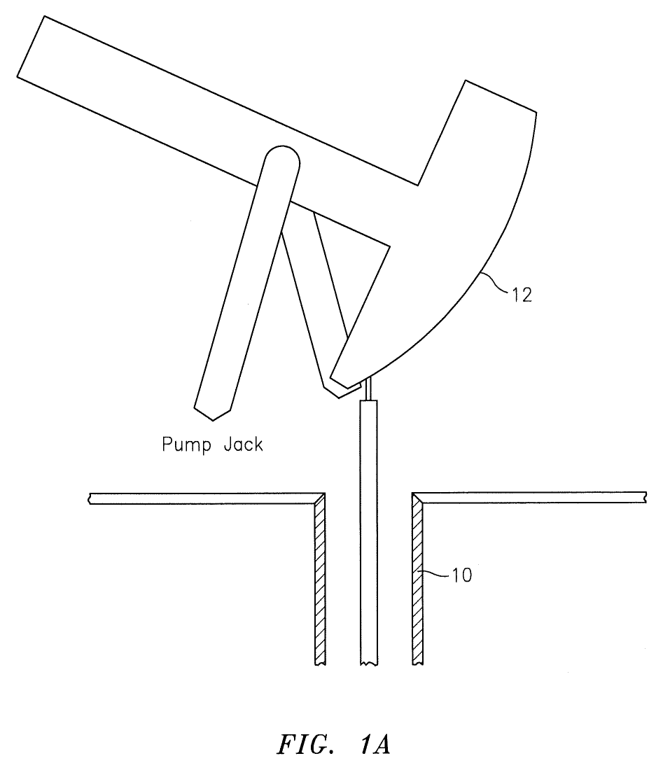

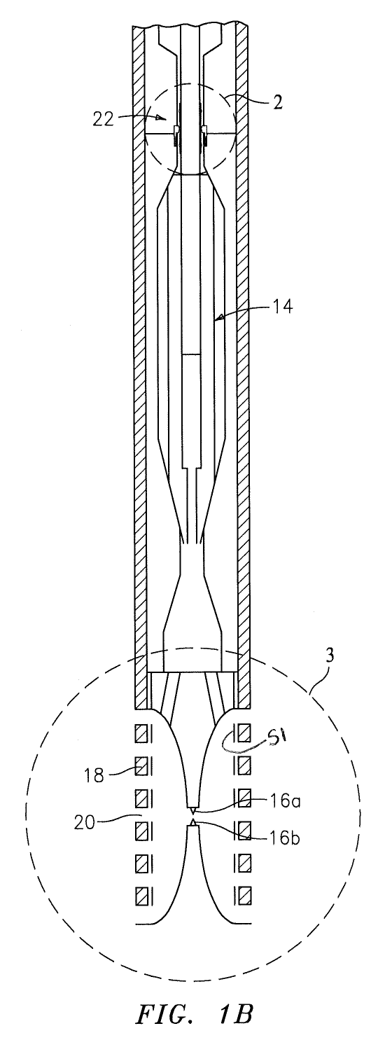

Referring to FIGS. 1A and 1B, an overview is provided of a wellbore 10, a pump jack 12 and a spark-gap tool 14. As illustrated, the spark-gap tool includes a pair of electrodes 16a and 16b located within a section of pipe 18 having a plurality of openings 20. Further illustrated, generally, is a voltage generation arrangement 22. With arrangement 22 utilizing mechanical function in conjunction with one or more transducers, the problem in the prior art of supplying high voltage from surface and carrying that voltage to the spark tool has been eliminated. Because the voltage generation arrangement can be located proximate the spark-gap electrodes 16a and 16b, voltage loss (due to distance) is not a factor.

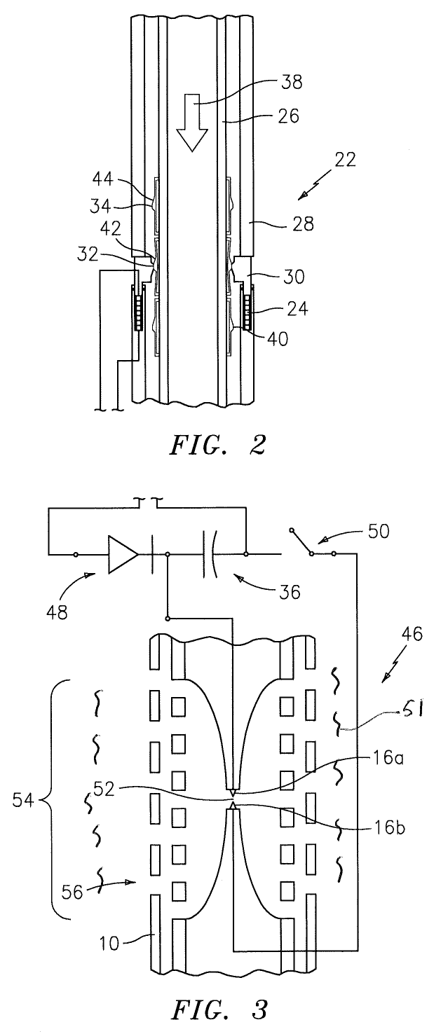

Referring to FIG. 2, one embodiment of a mechanical voltage generation arrangement 22 is depicted in more detail. Central to this embodiment is a piezoelectric element 24 (transductive element). A piezoelectric element is a transducer and thereby capable of creating a voltage potential when subjected to a mechanical energy input in any selected direction or combination of directions causing physical distortion of the element.

In this embodiment, mechanical energy input is provided through a configuration described hereunder, to the piezoelectric element(s) 24 to produce the desired voltage. In specific embodiments hereof, the mechanical energy may be imparted to the element(s) 24 any number of times from one to infinity in order to produce a buildup of charges or a continuous charge or some combination of these. In one embodiment, the mechanical energy is provided by set down weight of an inner mandrel 26 of the spark-gap tool 14. Set down weight is operative when a tool housing 28 of the spark-gap tool 14 is anchored such that the mandrel 26 is moveable relative to the tool housing 28. The housing 28 may be anchored within casing 10 in any of a number of conventional ways and not shown. Because of the anchoring of the housing 28, that housing will no longer move downhole when further set down weight from the pump rig 12 is applied to the mandrel 26. Such application of mechanical energy is transmitted to a compression piston 30 (embodiment of force transmission configuration), which in turn is force transmissive communication with the piezoelectric element(s) 24. Mechanical energy (more generically deformative energy), which may include hydraulic, pneumatic, and even optic energy that could be used. The phrase “mechanical energy” as used herein is intended to also encompass these other ways of physically distorting the element(s) 24 applied to the compression piston causes a compression of the piezoelectric element 24 thereby creating the desired voltage potential in that element. It should be noted in passing that the piezoelectric element contemplated might be of a single crystalline variety or a polycrystalline variety, such as a ceramic material. Single crystalline varieties are more efficient but also are more costly to procure. Some ceramic materials operable as piezoelectric materials include barium titanate, lead zirconate, lead titanate, and lead zirconate titanate, etc. Since most ceramic materials are composed of random crystalline structure, in order to reliably produce the desired voltage potential upon mechanical energy input, the ceramic material must be polarized thereby aligning the individual crystals therein prior to use to generate a voltage potential. Polarization allows the structure to act more like a single crystalline piezoelectric material. Axiomatically, single crystalline varieties of piezoelectric elements do not require poling prior to use. The voltage potential generated is proportional to the thickness of the material in element 24 and the amount of physical distortion of the element, in turn related to the applied force thereon. In this particular embodiment the compression piston 30 is configured, at an internal dimension thereof, with a profile 32. The profile 32 includes specific features allowing it to engage and then release a collet mechanism or series of collet mechanisms 34. The specific features are rounded ridge type projections known in the art. Such ridges transfer a load until a predetermined maximum load is reached whereafter the ridge yields and drops the load.

In the particular embodiment illustrated in FIG. 3, collet mechanisms 34 are depicted. As illustrated, this embodiment provides for voltage buildup in a capacitor 36 by creating multiple compressive and release cycles on the piezoelectric element 24. As the mandrel 26 moves in the direction of arrow 38, profile 32 of compression piston 30 is picked up on collet ridge 40 and released, then picked up on collet ridge 42 and released, and then picked up on collet ridge 44. As illustrated, collet ridge 42 is at the release position with the collet 34 deforming to allow the ridge 42 to release the piston 30. During each compression cycle, the piezoelectric element generates a voltage, which is sent for storage to the capacitor 36. As the collet mechanism 34 deflects, the compression piston 30 is released thereby removing mechanical energy from the piezoelectric element 24. This will, in turn, eliminate the production of voltage from the piezoelectric element 24 and reset it to its natural position. Upon further motion of the mandrel 26, the next ridge 42 picks up profile 32, transmitting mechanical energy once again to the piezoelectric element 24. Upon release of each ridge 40, 42, 44, the collet mechanism 34 is deflected regularly inwardly relative to the mandrel 26. This can be seen in FIG. 2 with respect to the collet mechanism ridge 42. Although three collet mechanisms 34 are illustrated, more or fewer can be utilized as desired. Limitation in the number of collet mechanisms employable relates only to stroke possibilities for the mandrel 26. This may be limited by the pump jack 12 on the surface or may be limited by available open space within the wellbore or within the tool. In the illustrated embodiment, in order to generate additional voltage, one need merely move the mandrel 26 uphole resetting the collet mechanism(s) for a further movement in the downhole direction and thereby create three more pulsed electrical signals to be stored in the capacitor. Depending upon exactly how much voltage a particular application requires, the above-stated procedure may be repeated indefinitely to fully charge the capacitor prior to creating an arc across the electrodes 16a and 16b.

Referring to FIG. 3, the spark-gap portion 46 is illustrated very schematically. The device comprises a rectifier diode 48, the capacitor identified previously as 36, and a switch 50, which completes the circuit to either side of the spark gap 52. Once the circuit is completed, electrodes 16a and 16b function together to generate an arc that jumps over the spark-gap. Upon the formation of the arc, fluid located in the spark gap 52 is vaporized and a shockwave is initiated. Referring back to FIG. 1, and still referring to FIG. 3, this embodiment illustrates that the tool housing 28 includes perforated interval 54 located adjacent to spark-gap 52. The perforated interval may be a slotted pipe, a holed pipe, or other construction configured to allow propagation of the shockwave 51 generated at spark gap 52 through the tool housing 28. Since it may be desirable to propagate the shockwave into the formation itself, a casing segment radially outwardly disposed of the spark-gap tool would also have a perforated interval, schematically illustrated as 56.

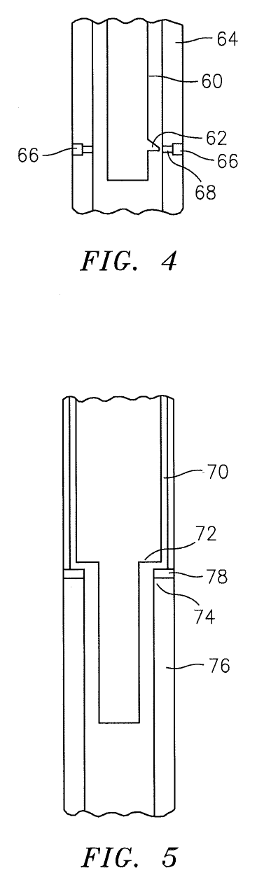

Mechanical energy may also be imparted utilizing rotational initiation. Referring to FIG. 4, a rotary mandrel 60 may be provided with one or more actuator bumps 62. In a tool housing 64 surrounding the mandrel 60, one or more piezoelectric elements 66 are installed. In this embodiment, one or more compression pistons 68 are located between the piezoelectric elements 66 and the bump or bumps 62. It is noted that in some applications the pistons 68 may be omitted and contact between bump or bumps 62 directly with element or elements 66 may be had. Upon rotation of mandrel 60, sequential elements 66 will be compressed and released. This will generate a voltage potential, which may then be stored in a capacitor similar to that depicted in FIG. 3 or may simply be used without storage if appropriate for the application. This arrangement will then be connected to the spark gap electrodes.

In yet another embodiment of the mechanical energy arrangement, referring to FIG. 5, a mandrel 70 is configured with a shoulder 72 that has an offset profile such that a portion of shoulder 72 will be in contact with a relatively small portion of a counter shoulder 74 located within the spark-gap tool housing 76. Located at 78, around the periphery of housing 76, are one or more piezoelectric elements, which can be mechanically, compressed one after the other as mandrel 70 rotates. It should also be noted that a compression piston arrangement such as, for example, a metal disk may be placed atop the element 78 to protect them from direct frictional degradation due to rotation of mandrel 70 but still allow the compressive force of shoulder 72 to cause the desired voltage potential in element(s) 78. As is clear from the drawing, however, such disk is not required but merely is optional.

Because of the permanent or at least long term nature of the foregoing embodiments that allow for integration of a spark gap system in a wellbore completion, a new form of hydrocarbon stimulation becomes available to the well operator that is especially useful for depleted wells. The present inventor has discovered that seismic energy directed to “far field” regions of a hydrocarbon recovery system over a sufficient amount of time causes increased mobility of formation hydrocarbons. Seismic energy creating a shockwave having a dominant range of frequencies from about 0.1 Hz (Hertz) to about 100 Hz is sufficient to reach the far field regions and energize the formation fluids to become more mobile.

In a target well, a completion including the apparatus described above is installed with the spark gap tool near or in the depleted strata. The spark gap tool is discharged periodically and in one embodiment in the range of about 12 times per minute with as large of amplitude as can be generated by the device and absorbed by the well itself The dominant frequencies however, as noted above, are to be as low as practicable such as in the range of about 0.1 to about 100 Hz as also noted above. Determining the maximum amplitude, and hence the desired amplitude for a particular tool and formation requires a determination of the formation fracture pressure. One exemplary arrangement will generate shock waves at amplitudes in the range of about 100 Mpa (Mega Pascal's) to about 0.2 Gpa (Giga Pascal's). If fracture of the well is not desired, amplitudes of the stimulation process must be kept below the fracture pressure. In some cases, dilation of the fractures by propagating waves may be desirable. It this case, amplitudes in excess of fracture pressure would be desirable. In one embodiment, the wave is formed as a cylindrical wave. The wave is formed and propagated into the formation through the provision of a reflector 90 that in one embodiment is configured as that of a concave paraboloid. This is illustrated in FIG. 1B and FIG. 3.

In one embodiment the frequency of the shockwave is controlled by sheathing the entire spark gap with a sealed elastomeric cylinder that is filled with a dielectric fluid such as alcohol or mineral oil, for example. This method and configuration for frequency control is borrowed from the teaching of U.S. Pat. No. 5,301,169 (which is incorporated herein by reference) that is directed to a wireline based testing tool.

In each case, the greatest energy transfer to the formation will occur if the spark gap device is located near and in some embodiments at the depleted strata. Further in some embodiments, the spark gap device is to be located in an immersed (liquid) condition.

It is important to note that although the embodiments for generating electrical power as disclosed above are highly suitable for the method and apparatus for far field stimulation, other sources of electrical energy can be substituted by the alternating current (AC) or direct current (DC) sources. For example, a piezoelectric configuration may be located near the spark gap tool and be physically distorted to produce an electrical current in a number of ways including rotation of a string, reciprocation of a string, vibration, temperature gradient, flow based generation apparatus, etc. Any of these type generation configurations may also be coupled to one or more capacitors, which will then charge until a discharge is desired.

While preferred embodiments have been shown and described, modifications and substitutions may be made thereto without departing from the spirit and scope of the invention. Accordingly, it is to be understood that the present invention has been described by way of illustrations and not limitation.

1. A completion mounted spark gap tool comprising:
a completion component housing;
a spark gap device having a plurality of electrodes at the housing and configured to produce a shockwave having a frequency in the range of about 0.1 to about 100 HZ;
a voltage source in operable communication with the electrodes

2. A spark-gap tool as claimed in claim 1, wherein the plurality of electrodes includes a ground.

3. A method for far field stimulation comprising:
powering a spark gap device;
generating a plurality of shockwaves having one or more dominant frequencies in the range of about 0.1 Hz to about 100 Hz over a period of time.

4. A method as claimed in claim 3 wherein the generating occurs 12 times per minute.

5. A method as claimed in claim 3 wherein the shockwaves have one or more dominant frequencies in the range of about 0.1 to about 100 Hz.

6. A method as claimed in claim 3 wherein the plurality of shockwaves are generated at amplitudes in a range of about 1000 MPa to about 0.2 GPa (Giga Pascal's).

7. A method as claimed in claim 3 further comprising positioning the spark gap device in a wellbore along with a completion string of the wellbore.

8. A method as claimed in claim 3 further comprising positioning the spark gap tool such that a shockwave generated thereby is propagated into a depleted strata.

9. A method as claimed in claim 3 further comprising positioning the spark gap tool at a depleted strata.

10. A method as claimed in claim 3 wherein the spark gap tool is positioned to be immersed in liquid.
